(19) United States
(12) Patent Application Publication
(10) Pub. No.: US 2007/0175267 A1
(43) Pub. Date: Aug. 2, 2007

(54) Gas sensor with increased heat resistance

(75) Inventors: Masanobu Yamauchi, Kariya-shi (JP); Takashi Kojima, Kasugai-shi (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/641,064

(22) Filed: Dec. 19, 2006

(30) Foreign Application Priority Data
Jan. 30, 2006 (JP) 2006-021026

(51) Int. Cl. G01N 7/00; G01N 27/26

(52) U.S. Cl. 73/31.05; 204/424

(57) ABSTRACT

A gas sensor is disclosed including a sensor element, an element holder, an atmosphere-side insulator, an atmosphere-side cover, and a pressing member interposed between a shoulder portion of the atmosphere-side cover and a base end face of the atmosphere-side insulator. A heat-transfer restricting support member is associated with at least one of the shoulder portion of the atmosphere-side cover, the base end face of the atmosphere-side insulator and the pressing member to allow the pressing member to be held in contact with the shoulder portion of the atmosphere-side cover and the base end face of the atmosphere-side insulator in a minimum contact surface fore thereby restricting a heat transfer from a distal end of the gas sensor to a base end thereof.

### CROSS REFERENCE TO RELATED APPLICATIONS

This application is related to Japanese Patent Application No. No. 2006-21026, filed on Jan. 30, 2006, the content of which is hereby incorporated by reference.

### BACKGROUND OF THE INVENTION

1. Technical Field of the Invention

The present invention relates to a gas sensor that can be used as a sensor for detecting a concentration of specified gas in measuring gases for use in controlling a combustion state of an internal combustion engine such as a vehicle engine.

2. Description of the Related Art

In related art, various attempts have heretofore been to provide gas sensors adapted to be mounted on exhaust systems of internal combustion engines such as engines of motor vehicles for measuring a concentration of specified gas such as oxygen contained in exhaust gases.

One of these gas sensors includes a gas sensor 100, shown in FIG. 9, which comprises a sensor element 910 for detecting a concentration of specified gas in measuring gases, an element holder 911 for inserting and fixedly supporting the sensor element 910, an atmosphere-side insulator 912 placed on the element holder 911 under a status to cover a base end portion of the sensor element 910, an atmosphere-side cover 913 provided in a position on a side of the base end of the element holder 911 under a status to cover a base end of the atmosphere-side insulator 912, and an outer cover 916 mounted on the atmosphere-side cover 913 on a base end thereof.

Further, a pressing member 914 is interposed between the atmosphere-side cover 913 and the atmosphere-side insulator 912 for pressing the same toward the element holder 911.

As shown in FIG; 9, furthermore, the gas sensor 100 also includes a ventilating portion, composed of a ventilation filter 917 sandwiched between the atmosphere-side cover 913 and the outer cover 916, that plays a role as a guide path having a waterproof function while passing atmospheric air therethrough.

Moreover, an elastic member 919 is mounted in an area inside the atmosphere-side cover 913 and the outer cover 916 at upper portions thereof and fixedly secured thereto by caulking, thereby ensuring waterproof of a base end of the gas sensor 100.

With such a structure shown in FIG. 9, the gas sensor 100 encounters heat troubles. More particularly, during operation of the gas sensor 100, a distal end of the gas sensor 100 is heated with exhaust gases. This causes a heat to be transferred from the distal end of the gas sensor 100 and pass through the element holder 911 to the atmosphere-side insulator 912, upon which the heat is further transferred from the atmosphere-side insulator 912 and passes through the pressing member 914, the atmosphere-side cover 913 and the outer cover 916 to the elastic member 919 and the ventilation filter 917. This causes thermal degradations to take place in the elastic member 919 and the ventilation filter 917, resulting in the occurrence of a risk to cause deteriorations in waterproof functions of these component parts.

In particular, with a view to addressing relatively high load acting on the atmosphere-side insulator 912, the atmosphere-side insulator 912 is usually made of alumina or the like with an increased load bearing. Since the atmosphere-side insulator 912 has a sufficiently larger bulk than that of the atmosphere-side cover 913, the atmosphere-side insulator 912 has a large heat capacity and has capability of transferring a large heat value. Therefore, there is a fear of a risk to occur for the large heat value to be transferred to the elastic member 919 and the ventilation filter 917 via the atmosphere-side insulator 912.

In addition, another attempt has heretofore been made to provide a gas sensor of another type. In this prior art, the gas sensor 200 includes an atmosphere-side insulator 812 that is partially held in contact with an atmosphere-side cover 813 as disclosed in Japanese Patent Application Publication No. 2004-144732. With such a gas sensor 200, the spring member 814 is mounted on the atmosphere-side insulator 812 and has spring elements held in press contact with an inner wall of the atmosphere-side cover 813 with a given pressing force for thereby fixedly securing the atmosphere-side insulator 812 in a given position.

However, as shown in FIG. 10, the gas sensor 200 takes the form of a structure wherein the atmosphere-side insulator 812 is not held in contact with an element holder 811. With the gas sensor 200 of such a structure, a less thermal degradations take place in an elastic member 819 and a ventilation filter 817 due to heat transfer from a distal ed of the gas sensor 200 to a base end thereof. Also, the spring member 814 has an object in nature to avoid damage to a sensor element 810. Thus, an issue arises with a difficulty of applying the spring 814 to the gas sensor 200 having a structure wherein the atmosphere-side cover 813 acts to press the atmosphere-side insulator 812 toward the distal end of the gas sensor 200.

### SUMMARY OF THE INVENTION

The present invention has been completed with a view to addressing the above issues and has an object to provide a gas sensor that has capability of restricting heat transfer from a distal end of the gas sensor to a base end thereof and has increased heat resistance.

To achieve the above object, one aspect of the present invention provides a gas sensor comprising a sensor element for detecting a concentration of specified gas in measuring gases, and an element holder through which the sensor element extends and is retained with the element holder. An atmosphere-side insulator is placed on a base end portion of the element holder so as to cover a base end portion of the sensor element, and an atmosphere-side cover, placed on the base end portion of the element holder so as to cover the base end portion of the atmosphere-side insulator, has a shoulder portion placed in face-to-face relation with a base end face of the atmosphere-side insulator. A pressing member is interposed between the shoulder portion of the atmosphere-side cover and the base end face of the atmosphere-side insulator. A heat-transfer restricting support member is associated with at least one of the shoulder portion of the atmosphere-side cover, the base end face of the atmosphere-side insulator and the pressing member to allow the pressing member to be held in contact with the shoulder portion of the atmosphere-side cover and the base end face of the atmosphere-side insulator in a minimum contact surface.

With such a structure set forth above, due to the heat-transfer restricting support member associated with at least one of the shoulder portion of the atmosphere-side cover, the base end face of the atmosphere-side insulator and the pressing member, the pressing member can be held in contact with the shoulder portion of the atmosphere-side cover and the base end face of the atmosphere-side insulator in a minimum contact surface. This is effective to restrict heat transfer from the atmosphere-side insulator to the atmosphere-side cover. As a result, less heat transfer take pace on an elastic member and a ventilation filter mounted on the base end of the gas sensor. This prevents thermal degradations from taking pace in the elastic member and the ventilation filter, enabling the provision of a gas sensor with increased heat resistance and increased long operating life.

With the gas sensor of the present embodiment, the heat-transfer restricting support member may comprise a plurality of convexed ribs, formed on the shoulder portion of the atmosphere-side cover, which are held in abutting engagement with the pressing member.

Due to a structure of the heat-transfer restricting support member composed of a plurality of convexed ribs formed on the shoulder portion of the -atmosphere-side cover, the heat-transfer restricting support member can be fabricated in a simple way.

That is, the heat-transfer restricting support member can be fabricated on the same step as that in which the atmosphere-side cover is formed by pressing. This causes no increase in the number of component parts, thereby achieving increased advantages with low cost.

In particular, due to the atmosphere-side cover having the heat-transfer restricting support member, the atmosphere-side cover can be held in contact with the pressing member in a minimal contact surface area with a less degree of heat transfer from the distal end of the gas sensor to the base end portion thereof. This prevents thermal degradations from taking place in the elastic member and the ventilation member fixedly mounted on the atmosphere-side cover at the base end portion thereof, while allowing the atmosphere-side cover to have increased strength.

With the gas sensor of the present embodiment, the heat-transfer restricting support member may comprise the pressing member that includes an annular member having a plurality of spring portions, extending radially outward from an outer periphery of the annular member, which are interposed between the shoulder portion of the atmosphere-side cover and the base end face of the atmosphere-side insulator.

With such a pressing member structured in the heat-transfer restricting support member, the pressing member and the atmosphere-side cover can be held in contact with each other in a minimal contact surface area, thereby restricting heat transfer from a distal end of the gas sensor to the base end portion thereof. This avoids thermal degradations of the elastic member and the ventilation filter mounted on the base end portion of the gas sensor, resulting in an increased operating life of the gas sensor.

With the gas sensor of the present embodiment, the heat-transfer restricting support member may comprise a plurality of convexed ribs, formed on the base end face of the atmosphere-side insulator, which are held in abutting engagement with the pressing member.

Due to a structure of the heat-transfer restricting support member composed of a plurality of convexed ribs formed on the base end face of the atmosphere-side insulator, the heat-transfer restricting support member can be fabricated in a simple way. That is, the heat-transfer restricting support member can be fabricated on the same step as that in which the atmosphere-side insulator is formed by molding. This causes no increase in the number of component parts, thereby achieving increased advantages with low cost.

In particular, due to the atmosphere-side insulator incorporating the heat-transfer restricting support member, the atmosphere-side insulator can be held in contact with the pressing member in a minimal contact surface area with a less degree of heat transfer from the distal end of the gas sensor to the base end portion thereof. This prevents thermal degradations from taking place in the elastic member and the ventilation member fixedly mounted on the atmosphere-side cover at the base end portion thereof.

With the gas sensor of the present embodiment, the heat-transfer restricting support member may comprise more than three convexed portions.

With such a structure, the convexed portions acting as the heat-transfer restricting support member can bear the load acting on the gas sensor in an axial direction thereof under a stabilized state, the gas sensor has increased load bearing. In addition, the convexed portions may be preferably located at three positions in light of decreasing a contact surface area between the shoulder portion of the atmosphere-side cover and a contact surface area between the pressing member and the base end face of the atmosphere-side insulator as less as possible.

Another aspect of the present invention provides a gas sensor comprising a sensor element for detecting a concentration of specified gas in measuring gases, an element holder including a housing adapted to be mounted on a gas flow passage and an element-side insulator, fixedly retained in the housing, for fixedly supporting the sensor element, and an atmosphere-side insulator placed on a base end portion of the element holder so as to cover a base end portion of the sensor element. An atmosphere-side cover, placed on the base end portion of the element holder and fixedly supported with the housing so as to cover the base end portion of the atmosphere-side insulator, has a shoulder portion radially extending inward from an outer periphery of the atmosphere-side cover in face-to-face relation with a base end face of the atmosphere-side insulator. A pressing member is interposed between the shoulder portion of the atmosphere-side cover and the base end face of the atmosphere-side insulator. A heat-transfer restricting support member includes a plurality of convexed ribs, formed on the shoulder portion of the atmosphere-side cover, which are held in abutting engagement with the pressing member in a minimum contact surface.

With such a structure, since the heat-transfer restricting support member includes a plurality of convexed ribs formed on the shoulder portion of the atmosphere-side cover, the heat-transfer restricting support member can be fabricated in a simple way. That is, the heat-transfer restricting support member can be fabricated on the same step as that in which the atmosphere-side cover is formed by pressing. This causes no increase in the number of component parts, thereby achieving increased advantages with low cost.

Moreover, since the atmosphere-side cover employs the heat-transfer restricting support member, the atmosphere-side cover can be held in contact with the pressing member in a minimal contact surface area with a less degree of heat transfer from the distal end of the gas sensor to the base end portion thereof. This prevents thermal degradations of the elastic member and the ventilation member fixedly mounted on the atmosphere-side cover at the base end portion thereof, while allowing the atmosphere-side cover to have increased strength.

Another aspect of the present invention provides a gas sensor comprising a sensor element for detecting a concentration of specified gas in measuring gases, an element holder including a housing adapted to be mounted on a gas flow passage and an element-side insulator, fixedly retained in the housing, for fixedly supporting the sensor element, and an atmosphere-side insulator placed on a base end portion of the element holder so as to cover a base end portion of the sensor element. An atmosphere-side cover, placed on the base end portion of the element holder and fixedly supported with the housing so as to cover the base end portion of the atmosphere-side insulator, has a shoulder portion radially extending inward from an outer periphery of the atmosphere-side cover in face-to-face relation with a base end face of the atmosphere-side insulator. A heat-transfer restricting support member acts as a pressing member and includes an annular member having a plurality of spring portions, extending radially outward from an outer periphery of the annular member, which are interposed between the shoulder portion of the atmosphere-side cover and the base end face of the atmosphere-side insulator.

With such a pressing member playing a role as the heat-transfer restricting support member, the pressing member and the atmosphere-side cover can be held in contact with each other in a minimal contact surface area, thereby restricting heat transfer from a distal end of the gas sensor to the base end portion thereof in an effective fashion. This avoids thermal degradations of the elastic member and the ventilation filter mounted on the base end portion of the gas sensor, resulting in an increased operating life of the gas sensor.

Another aspect of the present invention provides a gas sensor comprising a sensor element for detecting a concentration of specified gas in measuring gases, an element holder including a housing adapted to be mounted on a gas flow passage and an element-side insulator, fixedly retained in the housing, for fixedly supporting the sensor element, and an atmosphere-side insulator placed on a base end portion of the element holder so as to cover a base end portion of the sensor element. An atmosphere-side cover, placed on the base end portion of the element holder and fixedly supported with the housing so as to cover the base end portion of the atmosphere-side insulator, has a shoulder portion radially extending inward from an outer periphery of the atmosphere-side cover in face-to-face relation with a base end face of the atmosphere-side insulator. A pressing member is interposed between the shoulder portion of the atmosphere-side cover and the base end face of the atmosphere-side insulator. A heat-transfer restricting support member includes a plurality of convexed ribs, formed on the base end face of the atmosphere-side insulator, which are held in abutting engagement with the pressing member in a minimum contact surface.

Due to the provision of the heat-transfer restricting support member including a plurality of convexed ribs formed on the base end face of the atmosphere-side insulator, the heat-transfer restricting support member can be fabricated in a simple way. That is, the heat-transfer restricting support member can be simply fabricated during a molding step of the atmosphere-side insulator. This causes no increase in the number of component parts and the gas sensor can be manufactured at low cost.

In addition, the atmosphere-side insulator can be held in contact with the pressing member in a minimal contact surface area with a less degree of heat transfer from the distal end of the gas sensor to the base end portion thereof. This prevents thermal degradations from taking place in the elastic member and the ventilation member fixedly mounted on the atmosphere-side cover at the base end portion thereof.

Another aspect of the present invention provides a gas sensor comprising a sensor element for detecting a concentration of specified gas in measuring gases, an element holder including a housing adapted to be mounted on a gas flow passage and an element-side insulator, fixedly retained in the housing, for fixedly supporting the sensor element, and an atmosphere-side insulator, placed on a base end portion of the element holder so as to cover a base end portion of the sensor element, which has an upper protrusion and an annular base end face formed around the upper protrusion. An atmosphere-side cover, placed on the base end portion of the element holder and fixedly supported with the housing so as to cover the base end portion of the atmosphere-side insulator, has an annular shoulder portion radially extending inward from an outer periphery of the atmosphere-side cover in face-to-face relation with the annular base end face of the atmosphere-side insulator. A pressing member is interposed between the annular shoulder portion of the atmosphere-side cover and the annular base end face of the atmosphere-side insulator. A heat-transfer restricting support member includes a plurality of convexed ribs, formed on the annular shoulder portion of the atmosphere-side cover, which are held in abutting engagement with the pressing member in a minimum contact surface.

With such a structure, since the heat-transfer restricting support member includes a plurality of convexed ribs formed on the annular shoulder portion of the atmosphere-side cover, the heat-transfer restricting support member can be fabricated in a simple way. That is, the heat-transfer restricting support member can be fabricated during the step of forming the atmosphere-side cover by pressing. Therefore, no increase in the number of component parts takes place and, thus, the gas sensor can be manufactured at low cost.

Moreover, since annular shoulder portion of the atmosphere-side cover employs the heat-transfer restricting support member, the atmosphere-side cover can be held in contact with the pressing member in a minimal contact surface area with a less degree of heat transfer from the distal end of the gas sensor to the base end portion thereof. This prevents thermal degradations of the elastic member and the ventilation member fixedly mounted on the atmosphere-side cover at the base end portion thereof, while allowing the atmosphere-side cover to have increased strength.

Another aspect of the present invention provides a gas sensor comprising a sensor element for detecting a concentration of specified gas in measuring gases, an element holder including a housing adapted to be mounted on a gas flow passage and an element-side insulator, fixedly retained in the housing, for fixedly supporting the sensor element, and an atmosphere-side insulator, placed on a base end portion of the element holder so as to cover a base end portion of the sensor element, which has an upper protrusion and an annular base end face formed around the upper protrusion. An atmosphere-side cover, placed on the base end portion of the element holder and fixedly supported with the housing so as to cover the base end portion of the atmosphere-side insulator, has an annular shoulder portion radially extending inward from an outer periphery of the atmosphere-side cover in face-to-face relation with the annular base end face of the atmosphere-side insulator. A heat-transfer restricting support member acts as a pressing member and includes an annular member having a plurality of spring portions, extending radially outward from an outer periphery of the annular member, which are interposed between the annular shoulder portion of the atmosphere-side cover and the annular base end face of the atmosphere-side insulator.

With such a structure, the pressing member plays a role as the heat-transfer restricting support member and the pressing member and the annular shoulder portion of the atmosphere-side cover can be held in contact with each other in a minimal contact surface area. This restricts the heat transfer from a distal end of the gas sensor to the base end portion thereof in an effective fashion. This avoids thermal degradations of the elastic member and the ventilation filter mounted on the base end portion of the gas sensor, resulting in an increased operating life of the gas sensor.

Another aspect of the present invention provides a gas sensor comprising a sensor element for detecting a concentration of specified gas in measuring gases, an element holder including a housing adapted to be mounted on a gas flow passage and an element-side insulator, fixedly retained in the housing, for fixedly supporting the sensor element, and an atmosphere-side insulator, placed on a base end portion of the element holder so as to cover a base end portion of the sensor element, which has an upper protrusion and an annular base end face formed around the upper protrusion. An atmosphere-side cover, placed on the base end portion of the element holder and fixedly supported with the housing so as to cover the base end portion of the atmosphere-side insulator, has an annular shoulder portion radially extending inward from an outer periphery of the atmosphere-side cover in face-to-face relation with the annular base end face of the atmosphere-side insulator. A pressing member is interposed between the annular shoulder portion of the atmosphere-side cover and the annular base end face of the atmosphere-side insulator. A heat-transfer restricting support member includes a plurality of convexed ribs, formed on the annular base end face of the atmosphere-side insulator, which are held in abutting engagement with the pressing member in a minimum contact surface.

With such a structure, since the heat-transfer restricting support member includes a plurality of convexed ribs formed on the annular base end face of the atmosphere-side insulator, the heat-transfer restricting support member can be fabricated in a simple way. That is, the heat-transfer restricting support member can be simply fabricated on the annular base end face of the atmosphere-side insulator during a molding step thereof Thus, the gas sensor has no increase in the number of component parts and can be manufactured at low cost.

Moreover, the atmosphere-side insulator can be held in contact with the pressing member in a minimal contact surface area with a less degree of heat transfer from the distal end of the gas sensor to the base end portion thereof. This prevents thermal degradations from taking place in the elastic member and the ventilation member fixedly mounted on the atmosphere-side cover at the base end portion thereof.

### BRIEF DESCRIPTION OF THE DRAWINGS

FIG. 1 is a longitudinal sectional view of a gas sensor of a first embodiment according to the present invention.

FIG. 2 is a fragmentary enlarged cross sectional view of the gas sensor shown in FIG. 1 for illustrating a heat-transfer restricting support member associated with an atmosphere-side cover and a pressing member.

FIG. 3 is a cross sectional view taken on line A-A of FIG. 2.

FIG. 4 is a fragmentary enlarged cross sectional view showing a gas sensor of a second embodiment according to the present invention incorporating a pressing member acting as a heat-transfer restricting support member associated with the atmosphere-side cover and an atmosphere-side insulator.

FIG. 5A is a plan view showing the pressing member before spring portions are formed.

FIG. 5B is a plan view showing the pressing member after the spring portions are formed.

FIG. 6 a fragmentary enlarged cross sectional view showing a gas sensor of a third embodiment according to the present invention incorporating a heat-transfer restricting support member associated with an atmosphere-side insulator.

FIG. 7 is a cross sectional view taken on line B-B of FIG. 6.

FIG. 8 is a longitudinal sectional view of a gas sensor of a fourth embodiment according to the present invention.

FIG. 9 is a longitudinal sectional view of a gas sensor of the related art.

FIG. 10 is a longitudinal sectional view of another gas sensor of the related art.

### DETAILED DESCRIPTION OF PREFERRED EMBODIMENTS

Now, gas sensors of various embodiments according to the present invention are described below in detail with reference to the accompanying drawings. However, the present invention is construed not to be limited to such embodiments described below and technical concepts of the present invention may be implemented in combination with other known technologies or the other technology having functions equivalent to such known technologies.

In the following description, like reference characters designate like or corresponding parts throughout the several views. Also, in the following description, it is construed that a portion of a gas sensor adapted to be inserted to an exhaust gas pipe of an internal combustion engine of a motor vehicle is referred to as a “distal end” and an opposite side of the gas sensor exposed to an atmosphere is referred to as a “base end” or “base end portion”.

Also, it will be appreciated that the gas sensors of various embodiment according to the present invention may have a wide variety of applications to an oxygen sensor, an A/F sensor, a NOx sensor, etc.

### First Embodiment

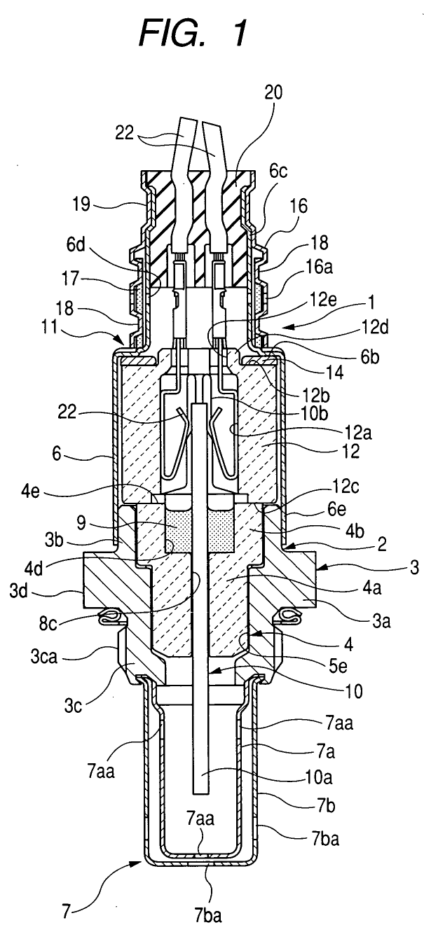

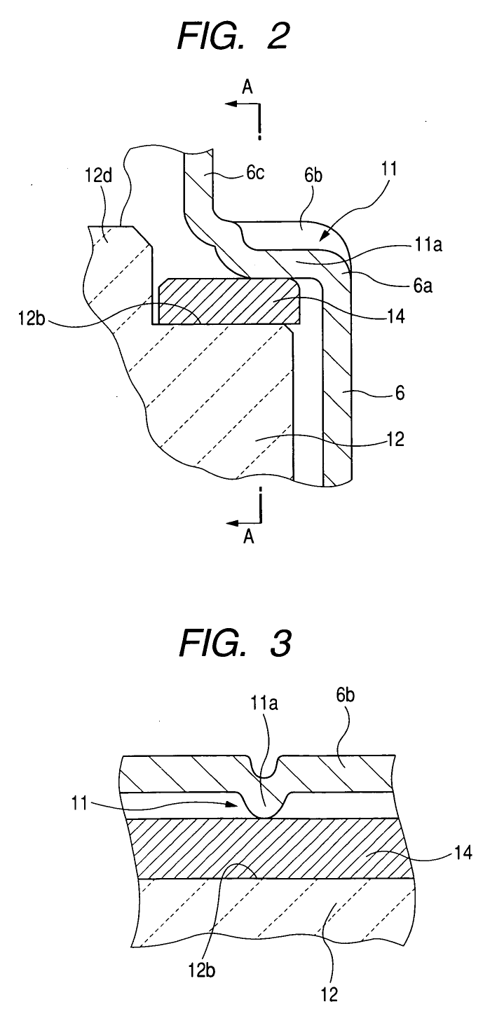

A gas sensor of a first embodiment according to the present invention is described below in detail with reference to FIGS. 1 to 3.

As shown in FIG. 1, a gas sensor 1 of the present embodiment comprises an element holder 2 composed of a housing 3 and an element-side insulator 4. The housing 3 includes a housing body 3a formed with an upper cylindrical portion 3b, acting as a base end, and a lower cylindrical portion 3b. An atmosphere-side cover 6 is fixedly supported on the upper cylindrical portion 3b of the housing 3 by welding, and an element protection cover 7 fixedly supported on an end face of the lower cylindrical portion 3c of the housing 3. The element protection cover 7 includes an inner protection cover 7a and an outer protection cover 7b having openings 7aa, 7bb, respectively. The housing body 3a is internally formed with a stepped bore 3e in which the element-side insulator 4 is accommodated and fixedly held in place. The element-side insulator 4 has a lower small diameter section 4a and an upper large diameter section 4b. The small diameter section 4a of the element holder 4 is formed with a through-bore 4c through which a sensor element 10 extends and is fixedly held in fixed position for detecting a concentration of specified gas contained in gas to be measured (hereinafter referred to as measuring gases). The large diameter section 4b of the element holder 4 has a large diameter bore 4d in coaxial relation with the through-bore 4c and is filled with a sealant 9.

An atmosphere-side insulator 12 is covered with the atmosphere-side cover 6 and placed on a base end face 4e of the element holder 4 in a position to cover a base portion of the sensor element 10 in an area closer to the base end 4e of the element holder 4. The atmosphere-side insulator 12 is internally formed with a cavity 12a and has upper and lower base end faces 12b, 12c. Moreover, the atmosphere-side insulator 12 has an upper protrusion 12d, protruding upward from the upper base end face 12b, which internally has a through-bore 12e.

The element holder 4 also has an outer periphery formed in a hexagonal shape 3d, and the lower end 3c has a threaded portion 3ca available to be screwed into a flow passage area of measuring gases to allow the sensor element 10 to detect measuring gases.

As shown in FIGS. 1 to 3, the gas sensor 1 further includes a heat-transfer restricting support member 11 that is associated with the atmosphere-side cover 6. The atmosphere-side cover 6 has an annular shoulder 6b formed on the atmosphere-side cover 6 at an upper end portion 6a thereof so as to extend radially inward from an outer periphery of the atmosphere-side cover 6. To effectively restrict heat transfer from the atmosphere-side insulator 12 to other associated component parts, the heat-transfer restricting support member 11 includes a plurality of radially extending convexed ribs 11a (with three ribs 11a being provided in the present embodiment) formed on the annular shoulder 6b of the atmosphere-side cover 6 to allow the annular shoulder 6b of the atmosphere-side cover 6 to have reduced heat transfer surfaces.

A ring-like pressing member 14 is interposed between the annular shoulder 6b of the atmosphere-side cover 6 and the upper base end face 12b of the atmosphere-side insulator 12 and held in press contact between the plurality of convexed ribs 11a of the heat-transfer restricting support member 11 and the upper base end face 12b of the atmosphere-side insulator 12 for pressing the atmosphere-side insulator 12 against the element holder 4.

As shown in FIG. 1, further, the atmosphere-side cover 6 has a base end section 6c, extending upward from an inner peripheral area of the annular flange 6b, which has an intermediate wall portion formed with a plurality of ventilation openings 6d at circumferentially spaced positions. The base end section 6c of the atmosphere-side cover 6 carries thereon an outer cover 16 formed with a plurality of ventilation openings 16a at circumferentially spaced positions in radial alignment with the ventilation openings 6d formed on the base end section 6c of the atmosphere-side cover 6.

A ventilation filer 17 is interposed between the base end section 6c of the atmosphere-side cover 6 and the outer cover 16 in a position to provide a waterproof function between the ventilation openings 16a of the outer cover 16 and the ventilation openings 6d of the base end section 6c of the atmosphere-side cover 6 while admitting atmospheric air to an inside of the atmosphere-side cover 6. Thus, the ventilation openings 6d of the base end section 6c of the atmosphere-side cover 6, the ventilation openings 16a of the outer cover 16 and the ventilation filer 17 provide a ventilating section. In assembly, the base end section 6c of the atmosphere-side cover 6 and the outer cover 16 are fixed to each other by means of caulked portions 18, 18 axially spaced from each other with the ventilation filter 17 intervening therebetween.

As shown in FIG. 1, furthermore, the base end section 6c of the atmosphere-side cover 6 and the outer cover 16 have a caulked portion 19 with which an elastic member 20 is fixedly supported. With such a configuration, the elastic member 20 allows the base end of the gas sensor 1 to have a waterproof function.

With the structure shown in FIG. 1, moreover, the sensor element 10 has an upper end whose opposing surfaces are formed with electrode terminals 10b. Spring terminals 22 are fixedly accommodated in the cavity 12a of the atmosphere-side insulator 12 and held in abutting contact with the electrode terminals 10b of the sensor element 10. The spring terminals 22 have end portions, extending through the through-bore 12e of the upper protrusion of the atmosphere-side insulator 12, which are electrically connected to one ends of wire leads 22 whose other ends are extracted to the outside.

In assembling the gas sensor 1 of the present embodiment, the sensor element 10 is inserted through and fixedly secured to the element-side insulator 4, which in turn is inserted to the stepped bore 3e of the housing 3. Then, the elastic member 20 is fixedly supported with the caulked portion 19, formed upon caulking the base end section 6c of the atmosphere-side cover 6 and the outer cover 16, while fixedly holding the wire leads 22 electrically connected to the spring terminals 22 accommodated in the cavity 12a of the atmosphere-side insulator 12 that is fixedly supported with the atmosphere-side cover 6. During subassembly between the atmosphere-side cover 6 and the atmosphere-side insulator 12, the pressing member 14 is interposed between the annular shoulder 6b of the atmosphere-side cover 6 and the annular base end face 12b of the atmosphere-side insulator 12 and fixedly supported in a fixed place by means of the heat-transfer restricting support member 11 directly formed on the annular shoulder 6b of the atmosphere-side cover 6. Thus, the atmosphere-side cover 6, in which the atmosphere-side insulator 12 and the pressing member 14 are fixedly retained, is fitted to the base end of the element holder 2 composed of the housing 3 and the element-side insulator 4. Thereafter, the base end 6e of the atmosphere-side cover 6 is fitted to the base end 3b of the housing 3, upon which the base end 6e of the atmosphere-side cover 6 and the base end 3b of the housing 3 are fixedly secured to each other by welding.

With the gas sensor 1 assembled in a status shown in FIG. 1, the pressing member 14 is pressed between bottom surfaces of the convexed ribs 11a of the heat-transfer restricting support member 11, associated with the annular shoulder 6b of the atmosphere-side cover 6, and the upper base end face 12b of the atmosphere-side insulator 12. This causes the lower base end face 12c of the atmosphere-side insulator 12 to be held in abutting engagement with the base ed face 4e of the element-side insulator 4.

In addition, the pressing member 14 acts to urge the atmosphere-side insulator 12 toward the distal end of the gas sensor 1.

As set forth above, the housing 3 has the hexagonal portion 3d and the thread portion 3ca. The gas sensor 1 is installed on an exhaust pipe of an engine such that the distal end of the gas sensor 1 is inserted to an interior of the exhaust pipe and the thread portion 3ca of the housing 3 is screwed thereto by turning the hexagonal portion 3d of the housing 3 with the use of a tool (not shown). Thus, the gas sensor 1 can be mounted to the exhaust pipe of the engine with the thread portion 3ca held in screw engagement with the exhaust pipe.

With the gas sensor 1 installed on the exhaust pipe in the sequence described above, the distal end of the gas sensor 1, such as the distal end portion 10a of the sensor element 10, a distal end of the element holder 2 and the element protection cover 7 are exposed to exhaust gas passing through the exhaust pipe (not shown).

During operation of the engine, exhaust gases emitted from a combustion chamber of the engine pass through the exhaust pipe and heat the distal end of the gas sensor 1.

When this takes place, a heat is transferred from the distal end of the gas sensor 1 to the element-side insulator 4 and the housing 3 forming the element holder 2. This heat is further transferred to the atmosphere-side insulator 12 held in abutting engagement with the base end face 4e of the element-side insulator 4. Then, the heat transferred to the atmosphere-side insulator 12 is further transferred to the pressing member 14, after which the heat is transferred to the elastic member 20 and the ventilation filter 17 via the atmosphere-side cover 6 including the heat-transfer restricting support member 11.

Now, the operation and advantages of the gas sensor 1 of the present invention is described below in detail.

With the structure of the gas sensor 1 mentioned above, the atmosphere-side cover 6 is held in pressured contact with the pressing member 4 by means of the plurality of convexed ribs 11a of the heat-transfer restricting support member 11 as shown in FIGS. 1 to 3. This enables a reduction in contact surface area between the annular shoulder 6b of the atmosphere-side cover 6 and the pressing member 4, thereby effectively restricting heat transfer from the atmosphere-side insulator 12 to the atmosphere-side cover 6. This results in capability of avoiding thermal degradations of the elastic member 20 and the ventilation filter 17 placed on the base end portion 6c of the atmosphere-side cover 6, thereby enabling the production of the gas sensor 1 with increased heat resistance.

Further, since the heat-transfer restricting support member 11 has a structure including the convexed ribs 11a directly formed on the annular shoulder 6b of the atmosphere-side cover 6 as shown in FIGS. 1 to 3, the atmosphere-side cover 6 has a remarkably minimized reduced contact surface area between the pressing member 14 and the atmosphere-side cover 6. This enables the heat to be adequately prevented from transferring from the distal end of the gas sensor 1 to the base end portion thereof. Also, the provision of the heat-transfer restricting support member 11 including the convexed ribs 11a enables the atmosphere-side cover 6 to have increased strength in structure.

Furthermore, the heat-transfer restricting support member 11 is composed of three convexed ribs 11a integrally formed with the annular shoulder 6b of the atmosphere-side cover 6. The convexed ribs 11a allow the atmosphere-side cover 6 to reliably hold the pressing member 14 against the base end face 12b of the atmosphere-side insulator 12 under a stabled condition to bear a load acting on the gas sensor 1 in an axial direction thereof. Thus, the gas sensor 1 can have increased load bearing. In addition, a decreased contact surface area between the annular shoulder 6b of the atmosphere-side cover 6 and the pressing member 14 can be obtained.

As set forth above, with the present embodiment, the gas sensor 1 can effectively restricts heat transfer from the distal end to the base portion and have excellent heat resistance.

### Second Embodiment

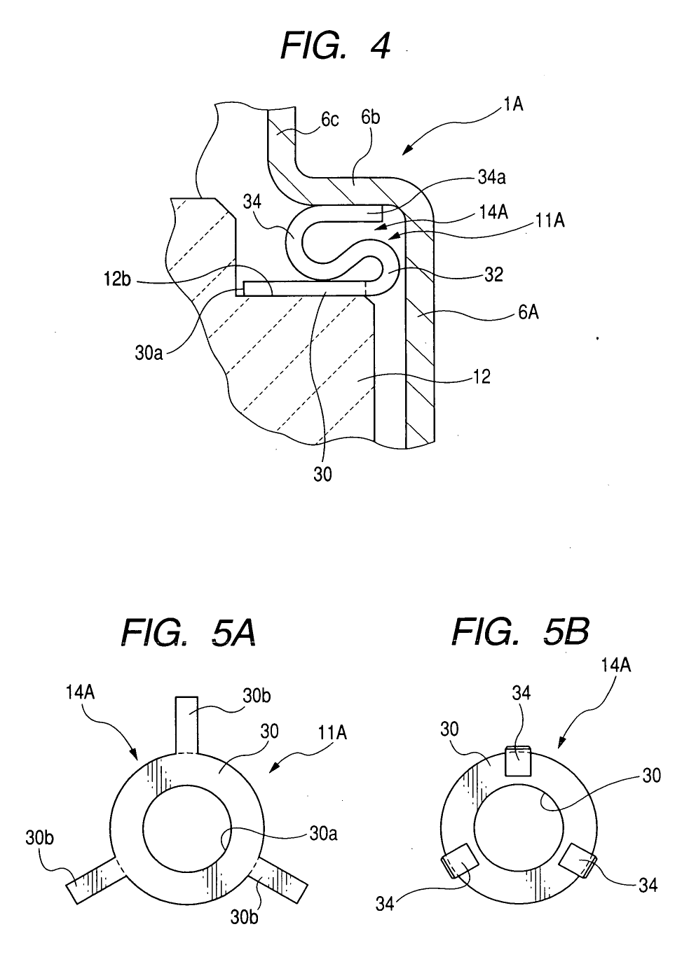

A gas sensor 1A of a second embodiment according to the present invention is described below in detail with reference to FIG. 4 and FIGS. 5A and 5B.

FIG. 4 is a fragmentary cross sectional view showing an essential part of the gas sensor 1A. FIG. 5A is a plan view showing a stamped state of a component part of a heat-transfer restricting support member 11A and FIG. 5B is a plan view showing a final stage of the heat-transfer restricting support member 11A.

The gas sensor 1A of the second embodiment differs from the gas sensor 1 of the first embodiment in that the annular shoulder 6b of the atmosphere-side cover 6 has no convexed ribs 11a and the heat-transfer restricting support member 11 is replaced with the heat-transfer restricting support member 11A.

With the gas sensor 1A of the present embodiment, more particularly, the heat-transfer restricting support member 11A comprises a pressing member 14A composed of an annular member 30 having a central bore 30a and a plurality of radially extending spring elements 30b (with the annular member 30 being shown as having three spring elements 30b in the present embodiment). As shown in FIG. 4, each of the spring elements 30b has a first folded portion 32 radially extending from an outer periphery of the annular member 30 and bent radially inward and a second folded portion 34 contiguous with the first folded portion 32 and folded back radially outward, with the first and second folded portions 32, 34 being formed in an S-shape in cross section.

With the annular member 30 of such a structure, the three radially extending spring portions 30b act as convexed portions, respectively, which serve as the heat-transfer restricting support member 11A.

In assembly, the upper protrusion 12d of the atmosphere-side insulator 12 is inserted to the bore 30a of the annular member 30. Under such a condition, the heat-transfer restricting support member 11A is interposed between the base end face 12b of the atmosphere-side insulator 12 and the annular shoulder 6b of the atmosphere-side cover 6 such that a bottom surface of the annular member 30 is held in contact with the base end face 12b of the atmosphere-side insulator 12 and end portions 34a of the second folded portions 34 of the annular member 30 are held in contact with the annular shoulder 6b of the atmosphere-side cover 6 as shown in FIG. 4.

With the gas sensor 1A of the present embodiment, the annular shoulder 6b of the atmosphere-side cover 6 is partially held in abutting engagement with the pressing member 14 by means of the spring portions 30b radially extending from the annular member 30. This results in a reduction in a surface contact area between the annular shoulder 6b of the atmosphere-side cover 6 and the pressing member 14, thereby restricting the heat transfer from the distal end of the gas sensor 1A to the base end thereof in a highly reliable fashion. Thus, the gas sensor 1A can have increased heat resistance. Although the second embodiment has been described with reference to an exemplary case where the annular member 30 has three radially extending spring portions 30b, it may be altered such that the annular member 30 has more than three radially extending spring portions 30b depending on needs.

### Third Embodiment

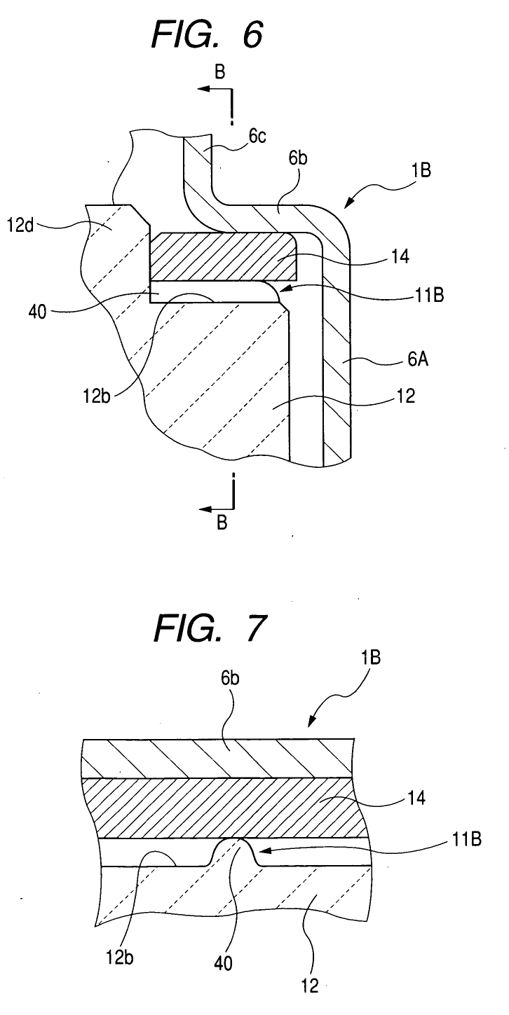

A gas sensor 1B of a third embodiment according to the present invention is described below in detail with reference to FIGS. 6 and 7.

FIG. 6 is a fragmentary cross sectional view showing an essential part of the gas sensor 1B. FIG. 7 is a cross sectional view showing the relationship between the housing and a heat-transfer restricting support member 11B.

The gas sensor 1B of the third embodiment differs from the gas sensor 1 of the first embodiment in that the annular shoulder 6b of the atmosphere-side cover 6 has no convexed ribs 11a and the heat-transfer restricting support member 11 is replaced with the heat-transfer restricting support member 11B.

With the gas sensor 1B of the present embodiment, more particularly, the heat-transfer restricting support member 11B comprises a plurality of radially extending convexed ribs 40 (with three convexed ribs 40 being shown in the present embodiment) directly formed on the base end face 12b of the atmosphere-side insulator 12.

In assembly, the pressing member 14 is interposed between the convexed ribs 40 formed on the base end face 12b of the atmosphere-side insulator 12 and the annular shoulder 6b of the atmosphere-side cover 6A such that a bottom surface 14a of the pressing member 14 is held in contact with the convexed portions 40 of the base end face 12b of the atmosphere-side insulator 12 as shown in FIGS. 6 and 7.

With the gas sensor 1B of the present embodiment, the bottom surface 14a of the pressing member 14 is partially held in abutting engagement with the convexed portions 40 of the base end face 12b of the atmosphere-side insulator 12. This results in a reduction in a surface contact area between the bottom surface 14a of the pressing member 14 and the base end face 12b of the atmosphere-side insulator 12, thereby restricting the heat transfer from the distal end of the gas sensor 1A to the base end thereof in a highly reliable fashion. Thus, the gas sensor 1B can have increased heat resistance.

### Fourth Embodiment

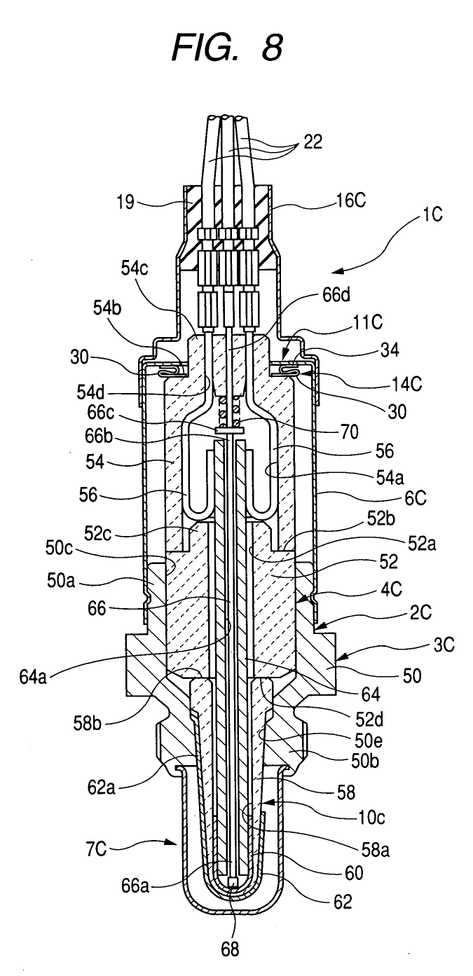

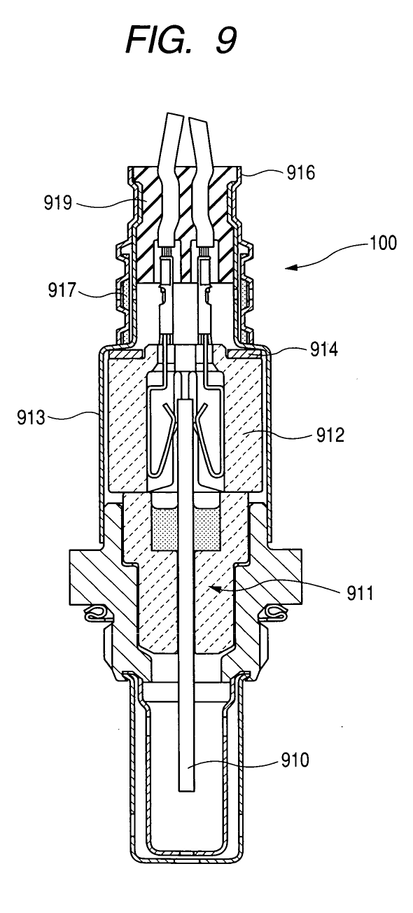

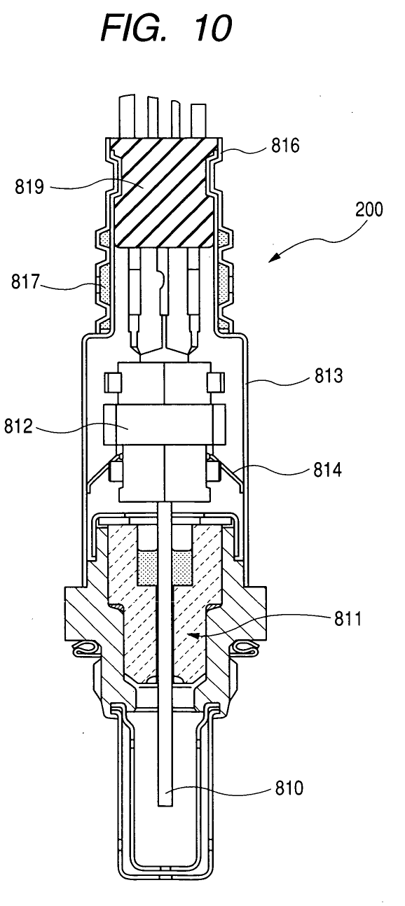

A gas sensor 1C of a fourth embodiment according to the present invention is described below in detail with reference to FIG. 8. FIG. 8 is a cross sectional view showing the gas sensor 1C.

With the gas sensor 1C of the present embodiment, an element holder 2C comprises a housing 3C and an element-side insulator 4C. The housing 3C includes a housing body 50 formed with an upper cylindrical base end 50a and a lower cylindrical portion 50b. The housing body 50 is internally formed with a large diameter bore 50c, an intermediate diameter bore 50d and a small diameter bore 50e formed in this order from an upper area to a lower area of the hosing body 50.

The large diameter bore 50c of the housing body 50 accommodates therein and fixedly supports the element-side insulator 4C. The intermediate diameter bore 50d and the small diameter bore 50e accommodate therein a sensor element 10C.

The element-side insulator 4C includes a cylindrical body 52, fitted to the large diameter bore 50c of the housing 3C, which has an upper base end face 52b in an annular shape and a cylindrical protrusion 52c axially extending from the upper base end face 52b of the element-side insulator 4C.

An atmosphere-side insulator 12C includes a cylindrical body 54 with substantially the same diameter with that of the cylindrical body 52 of the element-side insulator 4C. The cylindrical body 54 has a bore 54a, to which the cylindrical protrusion 52c of the element-side insulator 4C axially extends and which accommodate therein spring terminals 56 held in electrical contact with electrode terminals of a sensor element 10C, a base end face 54b formed in an annular shape, and a cylindrical protrusion 54c axially extending from the base end face 54b in an upper direction. The cylindrical protrusion 54c of the atmosphere-side insulator 12C has axially extending through-bores 54d, through which end portions of the spring terminals 56 extend for connection to the wire leads 22 supported with the elastic member 19.

An atmosphere-side cover 6C is fixedly supported on the base end 50a of the housing body 50 by caulking, and an element protection cover 7C is fixedly supported on an end face of the lower cylindrical portion 50b of the housing body 50 for protecting a low portion of the sensor element 10C.

The sensor element 10C comprises a solid electrolyte body 58 having an outer periphery tapered in shape and fitted to the intermediate diameter bore 50d and the small diameter bore 50e of the housing body 50. The solid electrolyte body 58 has an axially extending inner wall 58a and a base end face 58b held in abutting engagement with a distal end 53d of the cylindrical body 52 of the element-side insulator 4C.

The sensor element 10C further comprises an inner electrode 60, formed on the axially extending inner wall 58a at a lower portion thereof, and an outer electrode 62 formed on an outer periphery of the solid electrolyte body 58 at a lower portion thereof. The outer electrode 62 has an outer electrode lead portion 62a, made of the same material as that of the outer electrode 62 and axially extending from the outer electrode 62, which is held in contact with the inner periphery of the lower diameter portion 50e of the housing body 50.

The sensor element 10C further comprises a heater 64, axially extending through the through-bore 52a of the cylindrical body 52 of the element-side insulator 4C and inserted to the bore 58a of the solid electrolyte body 58. The heater 64 has through-bore 64a through which an inner electrode conducting lead portion 66 extends. The inner electrode conducting lead portion 66 has an element-side inner electrode conducting lead 66a, carrying thereon a contact 68 held in electrical contact with the inner electrode 60, and an upper end portion formed with an inner electrode conducting lead flange portion 66c on which a spring 70 is seated for permitting the contact 68 of the inner diameter conducting lead portion 66 to be held in pressured contact with the inner electrode 60 of the sensor element 10C. The inner electrode conducting lead portion 66 also has an upper extreme end portion 66d extending through the cylindrical protrusion of the atmosphere-side insulator 54 and connected to the lead wires 22 supported with the elastic member 19.

The atmosphere-side insulator 12C is covered with an atmosphere-side cover 6C having a lower end fixedly secured to the element holder 4C by caulking. A pressing member 14C includes a heat-transfer restricting support member 11C that has the same structure as that shown in FIGS. 5A and 5B.

As shown in FIG. 8, the heat-transfer restricting support member 11C is interposed between an annular shoulder 70 of the atmosphere-side cover 6C and the upper base end face 54b of the atmosphere-side insulator 12.

While the gas sensor 1C of the fourth embodiment shown in FIG. 8 has been described with reference to a case wherein the heat-transfer restricting support member 11C has the same structure as that shown in FIGS. 5A and 5B, the present invention is not limited to such a structure. That is, the heat-transfer restricting support member 11C may be modified to have the same structure as the heat-transfer restricting support member 11 shown in FIGS. 1 to 3 or may take the form of the same structure as that shown in FIGS. 6 and 7.

While the gas sensors of the first to fourth embodiments have been described with reference to the structures employing each one of three types of heat-transfer restricting support members, a gas sensor may take the form of a structure that includes more than two types such as a heat-transfer restricting support member comprised of convexed ribs 11a formed on the annular shoulder 6b of the atmosphere-side cover 6, as shown in FIGS. 1 to 3, and convexed ribs 40 formed on the annular end face 12b of the atmosphere-side insulator 12 sown in FIGS. 6 and 7.

Further, the heat-transfer restricting support member may take the form of a structure that comprises concaved portions ore recessed portions formed in a contact portion between the pressing member and the annular shoulder of the atmosphere-side cover and a contact portion between the pressing member and the base end face of the atmosphere-side insulator.

While the specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention, which is to be given the full breadth of the following claims and all equivalents thereof.

What is claimed is:

1. A gas sensor comprising:
a sensor element for detecting a concentration of specified gas in measuring gases;
an element holder through which the sensor element extends and is retained with the element holder;
an atmosphere-side insulator placed on a base end portion of the element holder so as to cover a base end portion of the sensor element;
an atmosphere-side cover, placed on the base end portion of the element holder so as to cover the base end portion of the atmosphere-side insulator, which has a shoulder portion placed in face-to-face relation with a base end face of the atmosphere-side insulator;
a pressing member interposed between the shoulder portion of the atmosphere-side cover and the base end face of the atmosphere-side insulator; and
a heat-transfer restricting support member associated with at least one of the shoulder portion of the atmosphere-side cover, the base end face of the atmosphere-side insulator and the pressing member to allow the pressing member to be held in contact with the shoulder portion of the atmosphere-side cover and the base end face of the atmosphere-side insulator in a minimum contact surface.

2. The gas sensor according to claim 1, wherein:
the heat-transfer restricting support member comprises a plurality of convexed ribs, formed on the shoulder portion of the atmosphere-side cover, which are held in abutting engagement with the pressing member.

3. The gas sensor according to claim 1, wherein:
the heat-transfer restricting support member comprises the pressing member that includes an annular member having a plurality of spring portions, extending radially outward from an outer periphery of the annular member, which are interposed between the shoulder portion of the atmosphere-side cover and the base end face of the atmosphere-side insulator.

4. The gas sensor according to claim 1, wherein:
the heat-transfer restricting support member comprises a plurality of convexed ribs, formed on the base end face of the atmosphere-side insulator, which are held in abutting engagement with the pressing member.

5. The gas sensor according to claim 1, wherein:
the heat-transfer restricting support member comprises more than three convexed portions.

6. A gas sensor comprising:
a sensor element for detecting a concentration of specified gas in measuring gases;
an element holder including a housing adapted to be mounted on a gas flow passage and an element-side insulator, fixedly retained in the housing, for fixedly supporting the sensor element;
an atmosphere-side insulator placed on a base end portion of the element holder so as to cover a base end portion of the sensor element;
an atmosphere-side cover, placed on the base end portion of the element holder and fixedly supported with the housing so as to cover the base end portion of the atmosphere-side insulator, which has a shoulder portion radially extending inward from an outer periphery of the atmosphere-side cover in face-to-face relation with a base end face of the atmosphere-side insulator;
a pressing member interposed between the shoulder portion of the atmosphere-side cover and the base end face of the atmosphere-side insulator; and
a heat-transfer restricting support member including a plurality of convexed ribs, formed on the shoulder portion of the atmosphere-side cover, which are held in abutting engagement with the pressing member in a minimum contact surface.

7. A gas sensor comprising:
a sensor element for detecting a concentration of specified gas in measuring gases;
an element holder including a housing adapted to be mounted on a gas flow passage and an element-side insulator, fixedly retained in the housing, for fixedly supporting the sensor element;
an atmosphere-side insulator placed on a base end portion of the element holder so as to cover a base end portion of the sensor element;
an atmosphere-side cover, placed on the base end portion of the element holder and fixedly supported with the housing so as to cover the base end portion of the atmosphere-side insulator, which has a shoulder portion radially extending inward from an outer periphery of the atmosphere-side cover in face-to-face relation with a base end face of the atmosphere-side insulator;
a heat-transfer restricting support member acting as a pressing member and including an annular member having a plurality of spring portions, extending radially outward from an outer periphery of the annular member, which are interposed between the shoulder portion of the atmosphere-side cover and the base end face of the atmosphere-side insulator.

8. A gas sensor comprising:
a sensor element for detecting a concentration of specified gas in measuring gases;
an element holder including a housing adapted to be mounted on a gas flow passage and an element-side insulator, fixedly retained in the housing, for fixedly supporting the sensor element;
an atmosphere-side insulator placed on a base end portion of the element holder so as to cover a base end portion of the sensor element;
an atmosphere-side cover, placed on the base end portion of the element holder and fixedly supported with the housing so as to cover the base end portion of the atmosphere-side insulator, which has a shoulder portion radially extending inward from an outer periphery of the atmosphere-side cover in face-to-face relation with a base end face of the atmosphere-side insulator;
a pressing member interposed between the shoulder portion of the atmosphere-side cover and the base end face of the atmosphere-side insulator; and
a heat-transfer restricting support member including a plurality of convexed ribs, formed on the base end face of the atmosphere-side insulator, which are held in abutting engagement with the pressing member in a minimum contact surface.

9. A gas sensor comprising:
a sensor element for detecting a concentration of specified gas in measuring gases;
an element holder including a housing adapted to be mounted on a gas flow passage and an element-side insulator, fixedly retained in the housing, for fixedly supporting the sensor element;
an atmosphere-side insulator, placed on a base end portion of the element holder so as to cover a base end portion of the sensor element, which has an upper protrusion and an annular base end face formed around the upper protrusion;
an atmosphere-side cover, placed on the base end portion of the element holder and fixedly supported with the housing so as to cover the base end portion of the atmosphere-side insulator, which has an annular shoulder portion radially extending inward from an outer periphery of the atmosphere-side cover in face-to-face relation with the annular base end face of the atmosphere-side insulator;
a pressing member interposed between the annular shoulder portion of the atmosphere-side cover and the annular base end face of the atmosphere-side insulator; and
a heat-transfer restricting support member including a plurality of convexed ribs, formed on the annular shoulder portion of the atmosphere-side cover, which are held in abutting engagement with the pressing member in a minimum contact surface.

10. A gas sensor comprising:
a sensor element for detecting a concentration of specified gas in measuring gases;
an element holder including a housing adapted to be mounted on a gas flow passage and an element-side insulator, fixedly retained in the housing, for fixedly supporting the sensor element;
an atmosphere-side insulator, placed on a base end portion of the element holder so as to cover a base end portion of the sensor element, which has an upper protrusion and an annular base end face formed around the upper protrusion;
an atmosphere-side cover, placed on the base end portion of the element holder and fixedly supported with the housing so as to cover the base end portion of the atmosphere-side insulator, which has an annular shoulder portion radially extending inward from an outer periphery of the atmosphere-side cover in face-to-face relation with the annular base end face of the atmosphere-side insulator;
a heat-transfer restricting support member acting as a pressing member and including an annular member having a plurality of spring portions, extending radially outward from an outer periphery of the annular member, which are interposed between the annular shoulder portion of the atmosphere-side cover and the annular base end face of the atmosphere-side insulator.

11. A gas sensor comprising:
a sensor element for detecting a concentration of specified gas in measuring gases;
an element holder including a housing adapted to be mounted on a gas flow passage and an element-side insulator, fixedly retained in the housing, for fixedly supporting the sensor element;
an atmosphere-side insulator, placed on a base end portion of the element holder so as to cover a base end portion of the sensor element, which has an upper protrusion and an annular base end face formed around the upper protrusion;
an atmosphere-side cover, placed on the base end portion of the element holder and fixedly supported with the housing so as to cover the base end portion of the atmosphere-side insulator, which has an annular shoulder portion radially extending inward from an outer periphery of the atmosphere-side cover in face-to-face relation with the annular base end face of the atmosphere-side insulator;
a pressing member interposed between the annular shoulder portion of the atmosphere-side cover and the annular base end face of the atmosphere-side insulator; and
a heat-transfer restricting support member including a plurality of convexed ribs, formed on the annular base end face of the atmosphere-side insulator, which are held in abutting engagement with the pressing member in a minimum contact surface.
